(19) United States
(12) Patent Application Publication
(10) Pub. No.: US 2019/0270586 A1
(43) Pub. Date: Sep. 5, 2019

(54) Automatic Sanitary Napkin Receptacle

(71) Applicants: Shakita Lovingood, Henderson, NV (US); Erik Lovingood, Henderson, NV (US)

(72) Inventors: Shakita Lovingood, Henderson, NV (US); Erik Lovingood, Henderson, NV (US)

(21) Appl. No.: 16/290,916

(22) Filed: Mar. 3, 2019

Related U.S. Application Data
(60) Provisional application No. 62/638,283, filed on Mar. 4, 2018.

(51) Int. Cl. B65F 1/16

(52) U.S. Cl. CPC B65F 1/1623; B65F 1/067

(57) ABSTRACT

An automated sanitary napkin receptacle for discarded feminine hygiene products, that provides a discreet, easy to clean and sterile means of disposal. The system is a container comprising a mounted upper motor operated closure via a power source, controller, circuit board, and sensor encased with a storage unit and a detachable lower closure to hold and conceal the contained waste. The inside of the peripheral compartment contains a removable partition that exits from the bottom of the receptacle by way of a mounted lower closure to enable the removal of the inside bin containing the filled waste bag. The removable partition is assembled having an opening at the top without a closure and a closed bottom area. Perforated holes are located on the exterior rear of the outside receptacle to allow secure wall or fixture mounting.

### FIELD

The invention correlates to battery operated sanitary system and particularly a receptacle having novel features.

### BACKGROUND

Receptacles containing fids have a variety of uses in commercial operations. In particular, the majority of sanitary napkin receptacles contain hand operated lids to conceal discarded feminine products. The current method for the disposal of feminine hygiene products offers many risks in the majority of public restrooms. Disposal of sanitary napkins in both trash cans and current sanitary receptacles presents a multiplicity of risks to disease and infections due to improper exposure and physical contact with such containers. Various systems have been developed to service the disposal of feminine hygiene products to address the sanitary needs in public restrooms. Modern products include both trash cans with power operated lids and manually operated sanitary receptacles that may be located individually in each stall by affixation to a wall or in a centralized location in the restroom.

Current sanitary disposal systems do not provide the most discreet, convenient, safe, and effective means of disposal of feminine sanitary products. Individuals use these systems one after another, which doesn't allow adequate cleaning and sterilizing in-between uses. Additionally, both automated and manual receptacles fail to provide custodial personnel with safe and efficient means of emptying the receptacles of discarded wastes presenting a hazardous situation. When currently used containers become full and overflow with used sanitary products, bodily fluids are often present on and outside of the container, thus creating more susceptibility to acquire disease by contact of opening and closing the lid.

### SUMMARY

An aspect of at least one embodiment disclosed includes, an automated sanitary napkin receptacle apparatus with a removable internal bin to conceal discarded feminine hygiene products containing a bag. The automated receptacle and internal partition objection is to serve primarily as a touchless system and to create a viable alternative to traditional receptacles and trash can methods of disposing used sanitary products, to avoid contact with infectious diseases, germs and bacteria. In one embodiment, the bag can provide a negligible adhesive film on a top exterior surface of the internal bin and adhered lo the internal portion of the removable apparatus of the receptacle. The bag can also be presented in paper form and stand in an upright position and can be easily dumped from the top opening of the internal partition in a downward positon by custodial personnel. In another embodiment, a motor operated top closure containing an actuation arm and cross rod, activated by hand or bodily movement via a sensor, by way of controller, circuit board, and power source enclosed within a storage unit. Additionally another objective of the present invention is to comprise a lower closure located al the bottom of the container that can be mounted or converted to motor operated closure with power supply located for the extraction of the internal bin for emptying purposes.

The bottom closure conceals both the bottom of the internal partition and external apparatus while holding the internal partition, waste bag, and discarded wastes. Additionally in some embodiment the back of the external portion of the bin contains perforated holes to allow secure wall or fixture mounting. Another aspect in some embodiments, a closure position over a fraction of the receptacle at both the lop and bottom exterior receptacle; and a closure rotary attachment to secure to the top for concealment; where the closure includes a partial rectangular shape containing a from and back partition, where a back partition on both the top and bottom closures are positioned to partially cover the bin to allow opening and closing of the top closure, as the lid interchanges into an opening a closed position.

### BRIEF DESCRIPTION OF DRAWINGS

FIG. 1 is a perspective view of one embodiment of the present invention servo motor, actuation arm, and cross rod.

FIG. 2 is a front prospective view of the embodiment, of the present invention as shown in FIG. 1 expressing the removable internal bin.

FIG. 3 is a perspective view of the embodiment of the present invention with the upper closure fully opened as shown in FIGS. 1 and 2, absent the lower closure.

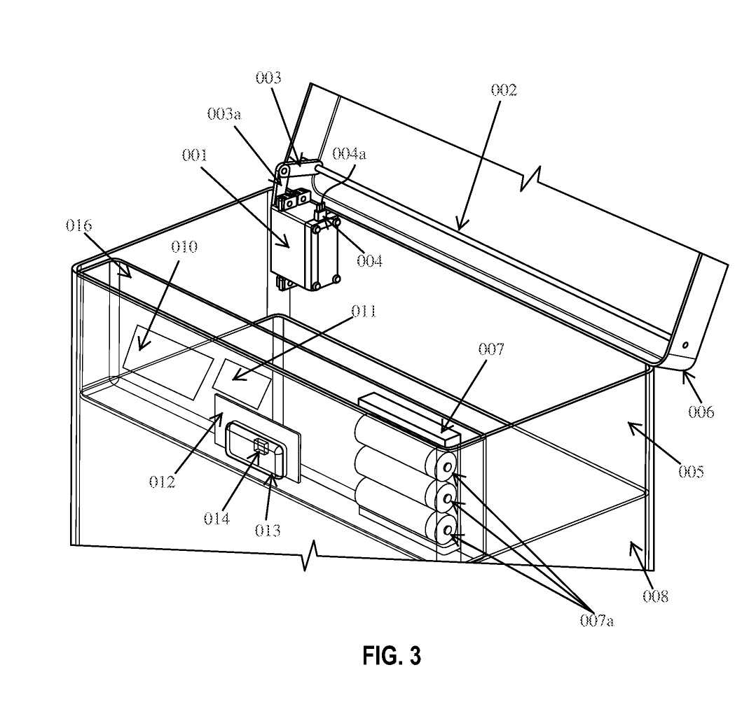

FIG. 4 is a perspective view of the embodiment of the present invention lower detachable closure as shown in FIG. 2.

FIG. 5 is a rear perspective view of the embodiment of the present invention as shown in FIG. 2.

FIG. 6 is front perspective view of the embodiment of the present invention as shown in FIGS. 1 and 2, absent lower detachable closure and inner removable bin.

### DETAILED DESCRIPTION OF DRAWINGS

In the following comprehensive descriptions, the apparatus in alignment with the provided directions for this submission in the form of an automated sanitary napkin receptacle will be defined by the embodiments. While the present states of the automated sanitary napkin receptacle which are described in the drawings are inclusive, it should be observed that modifications of future models of the specified apparatus can be accomplished. Modifications such as upgrades to the infrared motion sensor, the battery powered source and the electrical components (servo motor, main controller unit, actuator motor controller) as the technology continues to advance.

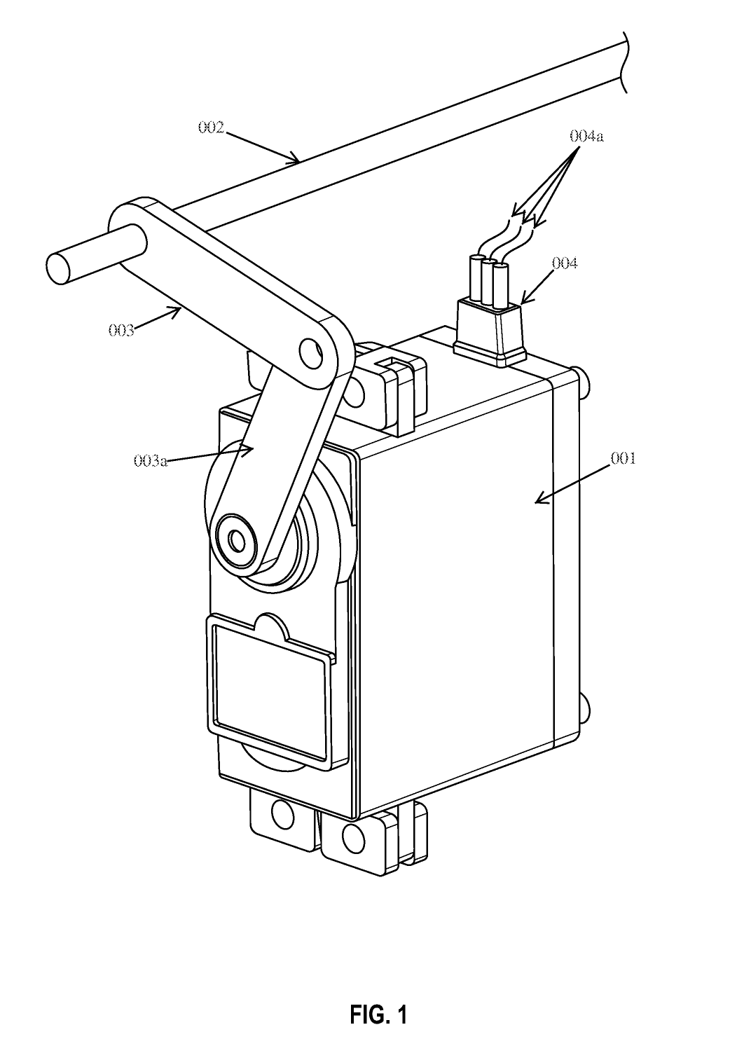

The first embodiment of the sanitary receptacle 000 is displayed in FIG. 1. The sanitary receptacle 000 incorporates a servo motor 001 which is illustrated on a larger scale in the first embodiment. The servo motor 001 encompasses a rotary actuator that permits for specific control of the angular position of the sanitary receptacle 000 lids 006 to be set within the range of 90-135° during the opening and closing process. When power to the sanitary receptacle 000 is activated through an electrical current sent into the servo motor's 001 power connection wires 004a, that current is then transferred into the servo motor's connector 004 which adjoins the servo motor's 001 power connection wire 004a to the servo motor 001, the actuation arm 003, 003b initiates its first set of movements.

During this process, the actuation arm 003, 003b is rotated into the “open” position which pushes the actuation cross rod 002 in the upward motion, subsequently lifting the lid 006 from the resting position of the 90° angle increasingly into the 135° angle at a constant speed of 0.012 sec per 60°. For a period of 10 through 30 seconds (to which this period of time can be can adjusted depending on the model of the servo motor utilized), the actuation arm 003, 003b maintains at the 135° angle, securely holding the lid 006 in the “open” position. Once the specified period of time has elapsed, the actuation arm 003, 003b begins to progressively rotate from the 135° angle to the 90° angle into the “closed” position, at the same speed detailed above. As the actuation arm 003, 003b performs this movement, the actuation cross rod 002 is lowered into the downward motion, which lowers the lid 006 hack into its original resting position.

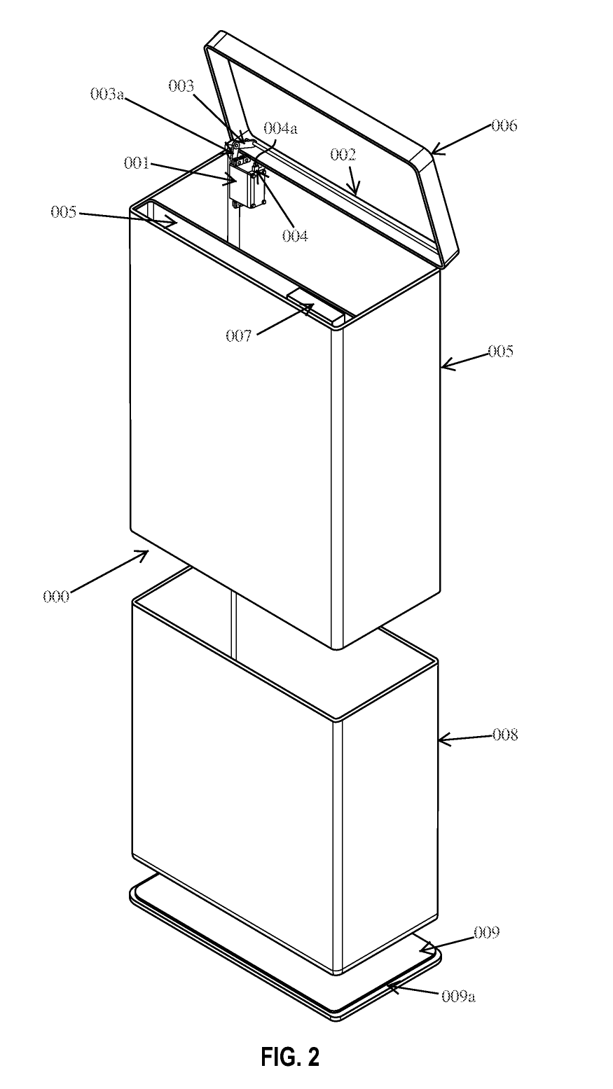

The second embodiment of the sanitary receptacle 000 is displayed in FIG. 2. The sanitary receptacle 000 illustration in the second embodiment provides an outward aspect of the sanitary receptacle 000 in its totality. The sanitary receptacle 000 is comprised of a series of containers along with a lid 006 and a removable bottom base 009. The first container is the outer housing container 005 which is the lynchpin that houses the summation of the components contained within the sanitary receptacle 000. The outer housing container 005 is a 3-dimensional orthotropic which is rectangular in shape, with each side exactly matching the adjacent side in length. Able to be made from a variety of different materials such as, stainless steel, aluminum, hardened plastic or and any variable form of a treated plastic, the outer housing container 005 is furnished to provide an outer shell for the sanitary receptacle 000 to allow tor discreet disposal of used feminine sanitary products as well as the general welfare and safety of the user of the receptacle.

Within the inside of the outer housing container 005, in the back upper right corner, the servo motor 001 is affixed to the back panel of the sanitary receptacle 000, to which the outer housing container 005 serves as the frame for secure attachment. Located also inside the outer housing container 005, is the component compartment 016 in the upper front portion, to which the battery pack housing 007 affixed. Other electrical components are affixed within the component compartment 016, which will be detailed in further detail in a later embodiment. The component compartment 016 is removable for the replacement of batteries or the other electrical components.

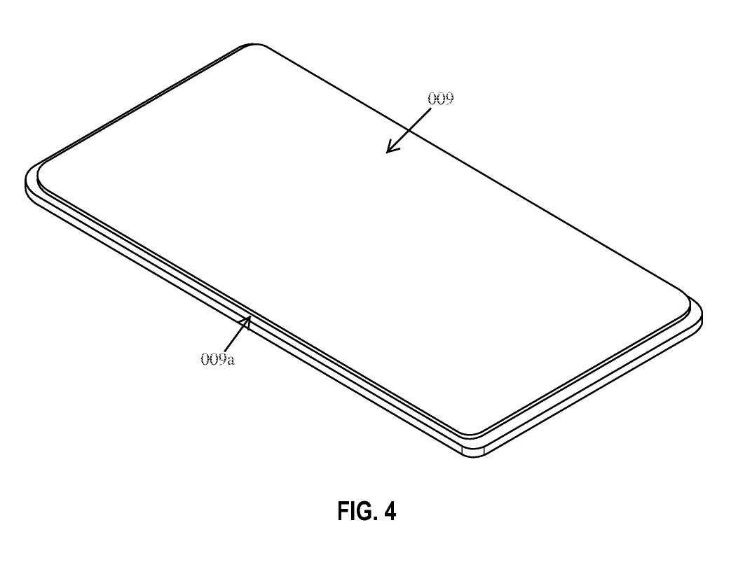

The current embodiment correspondingly illustrates the removable inner housing container 008. The removable inner housing container 008 is a 3-dimensional rectangular shaped container slightly smaller in dimensions (length, height, width), yet made from the same materials as the outer housing container 005. The inner housing container 008 is appropriately sized to fit inside the outer housing container 005 for the ability to be removed or inserted. Stopping at the base of the component compartment 016 inside the outer housing container 005, the removable inner housing container 008, is the frame for which sanitation bags will be placed for the insertion of used feminine sanitary products. FIG. 2's embodiment additionally illustrates the removable bottom base 009. When the removable inner housing container 008 is fully inserted into the outer housing container 005, the removable bottom base 009 securely attaches to the lower rim of the outer housing container 005 by the raised brim 009a. The raised brim 009a is located atop the removable bottom base 009 and takes the same shape of the removable bottom base 009 yet smaller in circumference. Thicker is size, the raised brim 009a protrudes in an outward fashion around the perimeter of the removable bottom base 009 for a firm seal to the outer housing container 005. The removable bottom base 009 secures the removable inner housing container 008 and its contents and conversely allows for the removal of the same the removable inner housing container 008. The removable bottom base 009 and the raised brim 009a are similarly illustrated on a larger scale in FIG. 4.

The third embodiment provides a similar aspect observed in the second embodiment; however a transparent illustration from a frontal view of the sanitary receptacle 000 is captured. The electronic components, which are the main controller unit 010, the actuator motor controller 011, and the infrared motion sensor 014, are likewise illustrated in this embodiment. In order for any of the electronic components to be properly utilized for their intended purpose, a series of actions must occur in this specific order. Batteries must be inserted into the battery pack housing 007 to supply power to the sanitary receptacle's 000 electronics. Once power is supplied, the sanitary receptacle 000 is placed in “sleep mode” until a motion such as the wave of a hand, is done in front of the infrared motion sensor 014. The infrared motion sensor 014 is fastened to the front panel within the inside of the component compartment 016 on a rectangular mounting plate 012. A small squared hole is cut into the inside panel of the component comportment 016 to which an identical squared hold is cut directly into the front of the outer housing container 005, to expose the infrared motion sensor's 014 sensor.

The infrared motion sensor 014 is placed within a protective case 013 to safeguard the infrared motion sensor 014 from damage. Once the infrared motion sensor 014 detects motion, the sanitary receptacle 000 is brought out of “sleep mode” and into an “operational mode”. The infrared motion sensor 014 sends an electrical current to the main controller unit 010. The main controller unit 010, which is fastened to the front left inside panel of the component compartment 016, receives the current across a connecting circuit and sends the same electrical current, across another circuit to the actuator motor controller 011, which is located directly next to the right of the main controller unit 010. The actuator motor controller 011 receives this current and then forwards it across yet another circuit to the servo motor 001 via the power connection wires 004a and the servo motor's connector 004. The receipt of this current, enables the servo motor's 001 actuation arm 003, 003b and actuation cross rod 002 to perform the respective movements for the opening of the lid 006, which was detailed in the first embodiment. After the allotted time of the servo motor 001 has been reached, the lid 006 closes, which is also outlined in the first embodiment, and the process is repeated during each use in the stated order of the current embodiment.

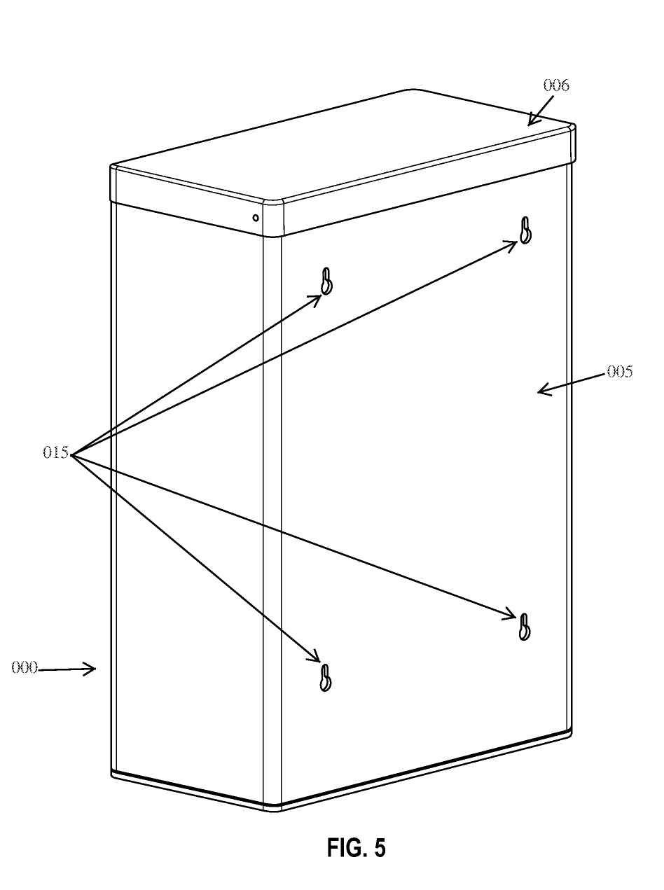

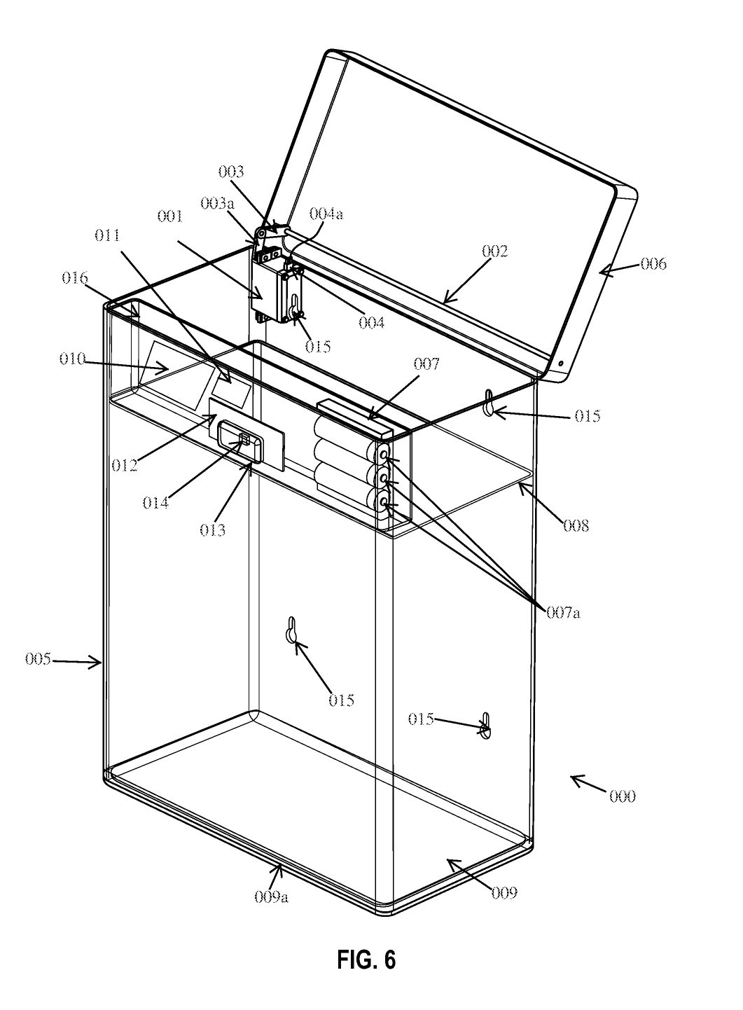

The fourth embodiment of the sanitary receptacle 000 is displayed in FIG. 5. Similar to the second embodiment, the illustration provides a view from the rear of the sanitary receptacle 000 with the perforated holes 015 shown. There are four total perforated holes 015 located on the back panel of the sanitary receptacle 000, for the securing of the sanitary receptacle 000 to a fixed wall or the wall of the stall it will be located. The fifth embodiment of the sanitary receptacle 000 is displayed in FIG. 6. The current embodiment illustrates a transparent view of the sanitary receptacle 000 with each component detailed in the previous embodiments, displayed. This view provides an overarching view of all previously mentioned elements of the sanitary receptacle 000 in their respective locations to provide an illustration of a completed the sanitary receptacle 000.

While the outlined teachings of each embodiment are described according to the corresponding figures to which that particular illustration is represented, it is comprehended that variations are allowed to the apparatus without deviating from the overall principle teachings of this submission. For example, the housing containers can be manufactured from an assortment of different materials which will alter the general appearance of the sanitary receptacle, yet is should be understood that changing the material of which the housing containers are made, will not alter the basic understanding of them being housing containers. Similarly, the placed electronic components will be rendered obsolete as technological advancements are attained. It should be understood that upgrades to these electronic components will not alter the prescribed functionality detailed in the teachings of this submission.

While all parts of each of all mentioned components within the detailed teachings of this application are not particularly described in its entirety, emphasis was placed on the essential parts of the detailed component. It should be comprehended that the Applicant claims protection in respect to any and all patentable features, combinations of upgrades or variations mentioned or shown in the attached drawings or detailed embodiments of this application, despite the absence of a particular emphasis placed on the functionality or particular part of any component mentioned therein.

The embodiments illustrated above of the present invention are intended to be expressive of the present invention and are not limited to latitude of the present invention. Various alterations, which would be readily ostensible to entities skilled in various aseptic disposals, apparatuses, are intended to be within the latitude of the present invention without any withdrawal from the present embodiments set forth of the present invention.

An automatic sanitary napkin disposal apparatus encompassing;

What is claimed is:

1. A defined shaped receptacle for slowing discarded sanitary napkin products having lids covering the upper and lower openings on the exterior receptacle; a receptacle wherein back panel of the receptacle has perforated holes for the purpose of secure mounting to walls; a lower detachable lid that partially horizontally covers base of the peripheral partition; a removable partition with a defined shape, located within the automatic receptacle that has a top opening; a motor attached within the peripheral partition comprising a cross rod and actuated arm; a power source; an additional inner storage unit containing power source, circuit, controller, mounting components, and sensor.

2. A receptacle according to claim 1 wherein the receptacle is a 3 dimensional, rectangular in shape.

3. A receptacle according to claim 1 wherein the upper opening consists of a lid that can move between open and closed positions.

4. A receptacle according to claim 1 wherein the lower opening consists of a removable lid.

5. A receptacle according to claim 3 wherein the removable base can be detachable, mounted by hinge, or motored operated that permits the removal of the internal partition and can configured to move between opened and closed positions.

6. A receptacle according to claim 3 wherein the lower removable base consists of a raised brim around the circumference of the removable base for secure attachment to the outer housing unit.

7. A receptacle according to claim 1 and 4 wherein the 3 dimensional receptacles consists of a removable inner housing container with an opening at the top for storing waste.

8. A receptacle according to claim 1 and 4 wherein the 3 dimensional receptacles consists of an outer housing container.

9. A receptacle according to claim 5 wherein a servo motor consists of an actuator arm that has range of movement from 90 to 135° but not limited to these specific degrees depending on the actuator utilized.

10. A receptacle according to claim 5 wherein an actuator cross rod runs through the inner lid with the purpose of raising and lowering the lid.

11. A receptacle according to claim 5 wherein a servo motor consists of power connection wires with the purpose of transferring received currents from a circuit into a servo motor connector.

12. A receptacle according to claim 5 and 6 wherein the power connection wires feed into a connector which serves as the bridge between for the received currents from the power connection wires into the servo motor.

13. A receptacle according to claim 7 wherein the inner housing unit serves as the point of fixation for a component compartment to be mounted on the front inner panel.

14. A receptacle according to claim 7 wherein the component compartment serves as the point of fixation for a battery housing unit to be mounted on the front inner panel which is the power source of the receptacle.

15. A receptacle according to claim 7 wherein the battery housing unit can be filled with the corresponding battery size.

16. A receptacle according to claim 5 and 7 wherein the storage compartment serves as the point of fixation for a main controller unit to be mounted on the front inner panel which sends the received currents from circuits sent by the battery housing unit the actuator motor controller.

17. A receptacle according to claim 7 wherein the inner housing unit serves as the point of fixation for an actuator motor controller to be mounted on the front inner panel sends the received currents from circuits sent by the main controller unit to the servo motor to control the movements of the actuator arm and actuator cross rod.

18. A receptacle according to claim 7 wherein the storage compartment serves as the point of fixation for a rectangular mounting plate to be mounted on the front inner panel.

19. A receptacle according to claim 7 wherein the rectangular mounting plate serves as the point of fixation for an infrared motion sensor which activates the all moving parts of the receptacle by motion.

20. A receptacle according to claim 7 wherein the infrared motion sensor is placed behind a protective case for prevention of damage to the infrared motion sensor.
